(19) United States
(12) Patent Application Publication
(10) Pub. No.: US 2004/0073470 A1
(43) Pub. Date: Apr. 15, 2004

(54) Resource management planning

(76) Inventors: James C. Wood, Essex, VT (US); Warren T. McFall, Boise, ID (US)

Correspondence Address: Ormiston & McKinney, PLLC, Suite 400, P.O. Box 298, 802 W. Bannock, Boise, ID, 83701-0298, US

(21) Appl. No.: 10/456,438

(22) Filed: Jun. 6, 2003

Related U.S. Application Data
(60) Provisional application No. 60/387,112, filed on Jun. 7, 2002.

(51) Int. Cl. G06F 17/60

(52) U.S. Cl. 705/8

(57) ABSTRACT

One method embodiment for resource management planning includes compiling regulatory requirements applicable to a resource, identifying the resource conditions that satisfy the compiled requirements, developing a computer implemented tool for selecting management practices that will satisfy the identified conditions when implemented, and all regulatory agencies interested in the compiled regulatory requirements agreeing that the selected management practices will satisfy the identified conditions when implemented. In one embodiment, a computer readable medium includes instructions thereon for making all regulatory requirements applicable to an agricultural resource available to an agricultural producer through a single source and then selecting management practices that will satisfy the regulatory requirements when implemented. In another embodiment, a computer readable medium includes instructions thereon for generating a resource management plan that addresses all regulatory requirements applicable to a resource.

### CROSS REFERENCE TO RELATED APPLICATION

This application claims subject matter disclosed in copending provisional patent application Ser. No. 60/387,112 filed Jun. 7, 2002, entitled Agricultural Resource Management Planning.

### STATEMENT OF RIGHTS TO INVENTIONS MADE UNDER FEDERALLY FUNDED RESEARCH AND DEVELOPMENT

Part of the work performed during the development of the Idaho OnePlan™ was funded by the United States Department of Agriculture CSREES under contract no. EWQI10547. The United States government may have certain rights in the invention.

### FIELD OF THE INVENTION

The present invention is directed generally to resource management planning.

### BACKGROUND

Farmers, ranchers and other agricultural producers manage the agricultural resources important to their crops, livestock or other products. Farmers, for example, evaluate field soil conditions to determine which crops are best suited for different fields and to optimize crop rotation and fertilization. Ranchers assess managed lands for livestock carrying capacity and necessary conservation practices. Milk producers seek to off-set disposal costs for huge volumes of animal waste against the value of this natural fertilizer.

Producers also must comply with laws and regulations enacted to conserve limited natural resources and to protect people and the environment from potentially damaging agricultural activities. Water quality standards adopted under the Clean Water Act, for example, may impact the application of fertilizer by a farmer, whether a farm uses flood or sprinkler irrigation, and how a dairy producer disposes of animal waste. In view of the increasing complexity and sophistication of modern agriculture, both in terms of production and regulation, it is essential that producers plan important resource management activities to help optimize production and profit as well as ensure regulatory compliance.

Since 1930, the U.S. Department of Agriculture Natural Resource Conservation Service (NRCS) has been charged with conserving agricultural lands, especially private lands, in the United States. Through the years, the NRCS developed a thorough conservation planning process, called the 9 Step Planning Process, which incorporates a grassroots approach for developing and delivering conservation through local conservation districts. The 9 Step Planning Process is described in detail in the NRCS National Planning Procedures Handbook. This process is complex and relies heavily on numerous time consuming manual tools used by professional agency planners. The substantial human resources necessary to implement this complex manual planning process limits the effectiveness of the process and, indeed, has prevented widespread application of the process to help agricultural producers develop conservation plans and then implement those plans on the ground.

The computer based techniques described below were developed by interested regulatory, service and educational agencies to overcome some of the problems associated with existing conservation and resource management planning processes. Agencies participating in the development include the U.S. Environmental Protection Agency, the U.S. Department of Agriculture Natural Resources Conservation Service, the U.S. Department of Agriculture Agricultural Research Service, the Idaho Department of Agriculture, the Idaho Soil Conservation Commission and the University of Idaho College of Agriculture and Cooperative Extension Office. Some of the new planning techniques are embodied in a computer program package currently available under the name Idaho OnePlan™. The Idaho OnePlan™ is a work in progress developed to provide agricultural producers with an easily accessible user-friendly tool for managing soil and water conservation activities according to information, guidelines and regulations from all interested local, state and federal agencies. The ultimate goal for the Idaho OnePlan™ is to allow producers to prepare one plan that addresses all resource conservation and environmental requirements for all agencies for his or her operation. The Idaho OnePlan™ currently helps producers prepare a Nutrient Management Plan that complies with all local, state and federal agency requirements. Methodology for a conservation planning module has been developed but not yet implemented in the Idaho OnePlan™ program package. Continuing efforts are directed to improving the Idaho OnePlan™ Nutrient Management module while also implementing the conservation planning methodology and developing pest, grazing and habitat management modules.

### BRIEF DESCRIPTION OF THE DRAWINGS

FIG. 1 illustrates a method used to develop a comprehensive computer based resource management planning tool.

FIG. 2 illustrates a method for creating and implementing a resource management plan in which an independent planner certifies completion of the plan and an independent professional monitors implementation of the plan.

FIG. 3 illustrates a method for creating and implementing a resource management plan in which an agricultural producer creates the plan, self-certifies it, and then notifies the designated agency that the plan has been completed.

FIG. 4A illustrates an Internet accessible mapping module and a PC based decision support program module for a resource management planning computer program package.

FIG. 4B illustrates a mapping module and a decision support program module residing on a web server.

FIG. 5 illustrates an opening screen that may be displayed when the computer program package of FIG. 4A is launched at the user's PC.

FIGS. 6-8 illustrate screens that may be displayed through the mapping module of the computer program package of FIG. 4A.

FIGS. 9-11 illustrate screens that may be displayed through the PC based decision support program module of FIG. 4A when the user is prompted to define farm or ranch fields or other planning units.

FIGS. 12-19 illustrate screens that may be displayed through the PC based decision support program module of FIG. 4A when the user is prompted to identify characteristics of the planning units.

FIGS. 20A-20C illustrate a directory and navigation tree for one embodiment of the PC based decision support program module of FIG. 4A.

### DESCRIPTION OF EXEMPLARY EMBODIMENTS

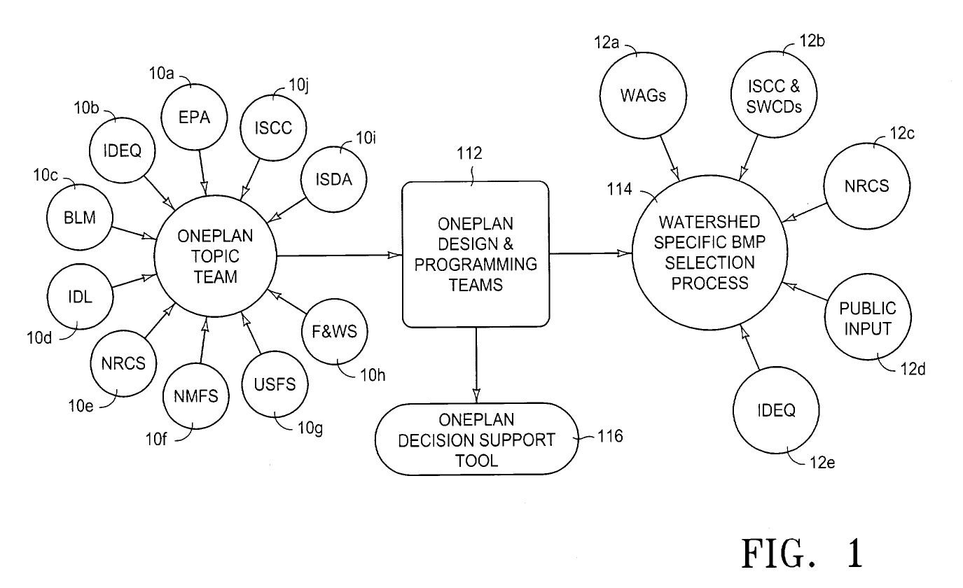

Overall Methodology For The Idaho OnePlan™. FIG. 1 illustrates the overall methodology used to develop a comprehensive resource management planning tool, which is also referred to as the decision support tool. In the implementation of this methodology described below, the decision support tool is the Idaho OnePlan™. Referring to FIG. 1, representatives from local, state and federal agencies 10a-10j having regulatory authority over agricultural producers for soil and water conservation activities convened as a topic team (step 110). Agencies identified by acronym in FIG. 1 are listed below.

EPA=U.S. Environmental Protection Agency

IDEQ=Idaho Department of Environment Quality

BLM=U.S. Bureau of Land Management

IDL=Idaho Department of Lands

NRCS=Natural Resource Conservation Service

NMFS=National Marine Fisheries Service

USFS=U.S. Forest Service

F&WS=U.S. Fish and Wildlife Service

ISDA=Idaho Department of Agriculture

ISCC=Idaho Soil Conservation Commission

WAG=Watershed Advisory Group

SWCD=Soil and Water Conservation District

The topic teams were tasked with identifying topics that must be addressed in any resource management plan if that plan is to address all applicable regulatory requirements. “All” regulatory requirements applicable to a resource, as that term is used in this document, means those requirements imposed by federal and state regulatory agencies that a resource producer must meet to be deemed in full compliance by each regulatory agency having an interest in any of the requirements.

While the NRCS 9 Step Planning Process is widely recognized and accepted among government agencies as the national standard for conservation planning on private lands, no attempt had ever been made to ensure the 9 Step Process met all regulatory requirements. In fact, the cumbersome nature of the 9 Step Process made any such comprehensive regulatory compliance all but impossible.

In theory, the topic team task is simple—compile all applicable regulatory requirements and identify the resource conditions necessary to satisfy those requirements. In practice, however, this task was anything but simple. First, the many regulations from many different agencies made charting the myriad regulating requirements alone a challenging task. Second, getting the regulatory agencies to agree to the notion of developing computer based rules that, by definition, address these requirements such that the agencies are committed up front to approve all plans created with these rules was, well, a very difficult task. Nevertheless, the team overcame these challenges and sent the requirements on to the design and programming teams (step 112).

Step 114 represents the development of watershed specific Best Management Practices (BMPs) by agencies and advisory groups 12a-12e required to implement the requirements of the Clean Water Act and other laws designed to protect the environment. Because these BMPs define on-the-ground resource management activities deemed sufficient to satisfy many regulatory requirements, they were used by the design and programming teams to define acceptable practices in the Idaho OnePlan™. In addition to watershed specific BMPs, the design and programming teams also incorporated other on-the-ground practices deemed sufficient by the governing agencies to address the regulatory requirements. In some cases, these practices were already known and used, and in other cases, the acceptable practices were developed by the design and programming teams. All of the regulatory requirements and their practice counterparts are then incorporated into the Idaho OnePlan™ decision support tool (step 116) and the agencies 10a-10h agree that any plan created through the proper execution of the decision support tool would, by definition, address all applicable regulatory requirements from the respective agencies (step 118).

So far as Applicants are aware, the notion of providing an agricultural producer with a comprehensive list of all regulatory requirements from all agencies in advance of on-the-ground activities is not only new, but revolutionary. Equally new and important is the collective recognition by all interested agencies that the Idaho OnePlan™ decision support tool, when properly executed, produces a plan that meets all applicable regulatory requirements. The producer is thereafter required only to implement the plan to achieve full regulatory compliance.

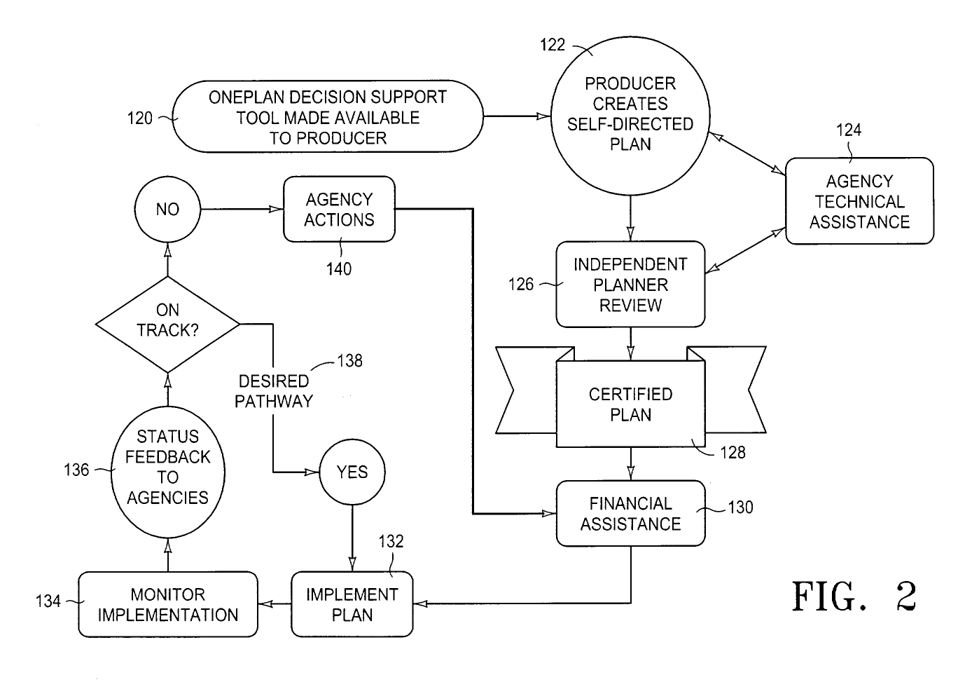

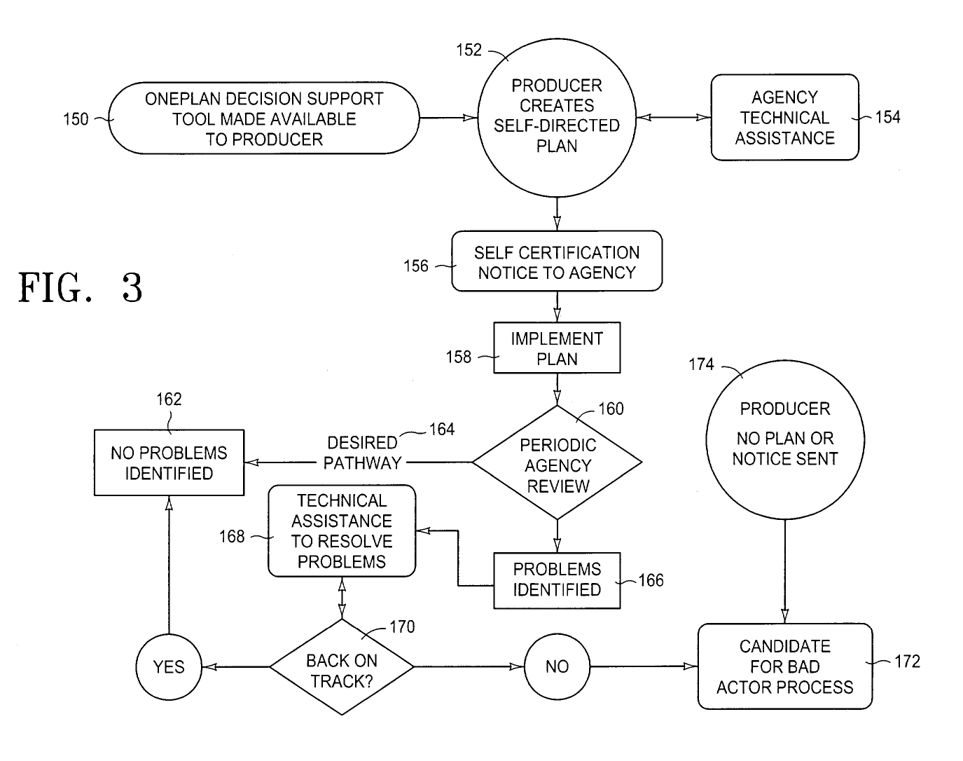

Producer Options For Regulatory Compliance. FIGS. 2 and 3 illustrate two options a producer may choose from for regulatory compliance. FIG. 2 illustrates a method for creating and implementing a resource management plan in which an independent certified planner may, if necessary, help the producer create the plan and an independent professional follows implementation of the plan. FIG. 3 illustrates a more streamlined method in which the producer creates the plan, self-certifies the plan and then notifies the designated agency, typically the local Soil and Water Conservation District, that the plan has been completed. This “self-certified” plan as well as implementation of the plan is subject to periodic agency review.

Referring first to FIG. 2, a decision support tool, the Idaho OnePlan™ in this example, is made available to the producer (step 120). In a preferred version of the Idaho OnePlan™ described below, the Idaho OnePlan™ computer program package is made available to producers in two parts. For one part of the package, the producer downloads geospatial information for her operation over the Internet from a designated web service. For the second part of the package, executable planning software is loaded on the producer's computer—this part of the package operates on the geospatial information downloaded from the web service to produce a resource management plan. The producer creates a resource management plan (step 122). Preferably, the plan is “self-directed” as noted in FIG. 2 in the sense that the planning software prompts the producer for the information necessary to determine management practices that must be implemented to comply with applicable regulatory requirements—management practices that are documented in the resource management plan created with the Idaho OnePlan™ decision support tool. The planning process is complex. It is expected, therefore, that in many instances, the local Soil and Water Conservation District or other appropriate agency will assist the producer in preparing and finalizing the plan as indicated in step 124.

The plan is reviewed by a certified planner (step 126). While producer creation in step 122 and planner review in step 126 may occur sequentially, more likely they will occur together. That is to say, that the certified planner will undertake review of the plan while the producer is developing the plan, all in connection with technical assistance from the local Soil and Water Conservation District. It is expected that this combined approach will help the producer reach plan certification as quickly and cost effectively as possible. Once the certified planner is satisfied the Idaho OnePlan™ decision making program has been properly executed against the relevant geospatial data, the plan is certified as addressing applicable regulatory requirements (step 128).

Certified planners need not be agency enforcement personnel knowledgeable in all phases of resource management—the certification process is not a re-hash of all that went into the development of the Idaho OnePlan™ decision support tool. Rather, certification represents the planner's judgment that the Idaho OnePlan™ program has been properly executed against relevant geospatial data. Therefore, the plan may be certified as addressing applicable regulatory requirements because all such requirements are, by definition, addressed by the Idaho OnePlan™ decision making program. Moreover, in the preferred embodiment in which each agency agrees to recognize certified plans as addressing all regulatory requirements, the producer can rely on certification as binding all such agencies. Two very significant advantages are realized from this methodology. First, the many individual agencies regulating producers don't have to send enforcers out to check on producers—the agencies can collectively monitor implementation of the plan without worrying about whether or not the plan itself adequately addresses individual agency requirements. Second, producers don't have to worry about piece-meal enforcement in which compliance with one agency requirement is often rewarded with a visit from another agency enforcer.

In an optional step 130, financial assistance is made available to the producer to off-set planning, certification and implementation costs. From an agency standpoint, there is greater regulatory certainty and likely lower agency costs associated with the certified plan option of FIG. 2 over the un-certified plan option of FIG. 3. Hence, it may be desirable to encourage producers to use the certified plan option through financial assistance, as reflected in step 130.

Following certification, the plan is implemented (step 132). Implementation is monitored by an independent certifying or other implementation agent (step 134). The monitoring agent reports the degree of compliance or non-compliance with the plan to the appropriate agencies (step 136). If the plan is being properly implemented and the producer is on track (the desired path 138), then no further action is required. If not, then agency action may be required to help the producer get back on track (step 140).

In the plan development and implementation option illustrated in FIG. 3, the decision making tool is made available to the producer (step 150) and the producer creates a plan with any technical agency assistance that might be necessary (steps 152 and 154). Once the plan is completed, the producer notifies the local Soil and Water Conservation District or other appropriate agency that the plan has been completed (step 156). Notice may be made by submitting a copy of the plan, or by a short form notice that the plan has been completed. In either event, the plan is then implemented (step 158) subject to periodic agency review to monitor compliance with the plan (step 160). If no problems are identified (step 162) and the producer is on track (the desired path 164), then no action is required. If problems are identified (step 166), technical assistance is offered to resolve the problems (step 168) to get the producer back on track (step 170). If the producer is unable or unwilling to get back on track, then she becomes a candidate for the bad actor process (step 172). Of course, if a producer refuses to submit a plan in the first place (step 174), she immediately becomes a candidate for the bad actor process.

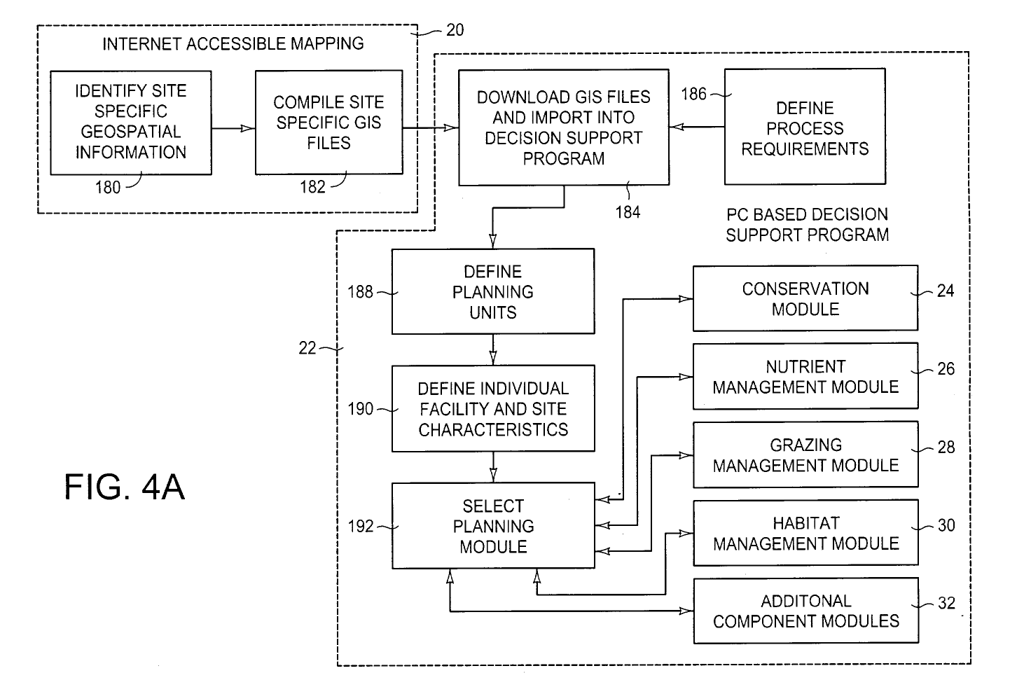

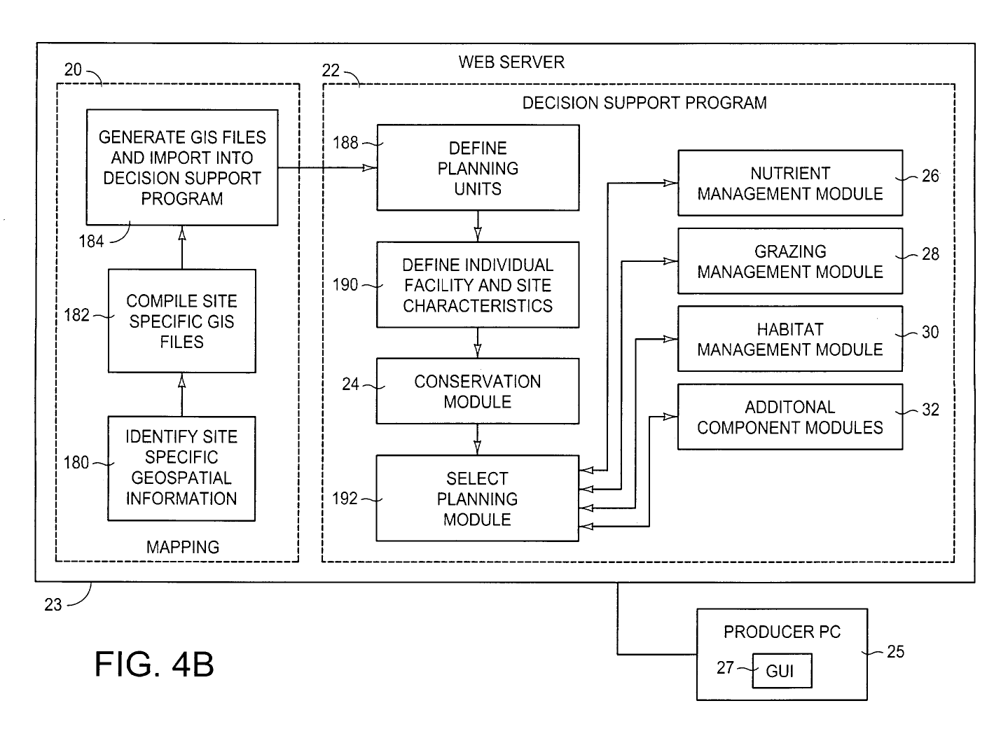

Internet Accessible Mapping. In one version of the Idaho OnePlan™ computer program package, the package is made available to producers in two parts, as illustrated in FIG. 4A—Internet accessible mapping module 20 and a PC based decision support program module 22. Mapping module 20 is maintained by a web service hosted by a web server accessible through the Internet. A “web server” as that term is used herein means any server that implements HTTP (Hypertext Transport Protocol). A web server can host a web site or a web service. A web site provides a user interface by supplying web pages to a requesting client, typically a web browser. Web pages can be delivered in a number of formats including, but not limited to, HTML (Hyper-Text Markup Language) and XML (eXtensible Markup Language). Web pages may be generated on demand using server and client side scripting technologies including, but not limited to, ASP (Active Server Pages) and JSP (Java Server Pages) and JavaScript. A web page is typically accessed through a network address. The network address can take the form of an URL (Uniform Resource Locator), IP (Internet Protocol) address, or any other unique addressing mechanism.

The web service provides access to web based decision support applications, mapping, aerial photography and geospatial data relevant to agricultural resource management for agricultural areas mapped and photographed. Geospatial data typically includes, for example, common resource areas, USDA-NRCS SSURGO certified soils data along with slope, composition and layer data needed to for nutrient management planning; climatic data; stream and waterway data; streams listed in Section 303(d) of the Clean Water Act that may be adversely impacted by contaminants transported from target farm fields; Universal Soil Loss Equation (USLE) C factor used in the Revised Universal Soil Loss Equation (RUSLE); Soil and Water Conservation District; fourth field hydrologic unit/watersheds; groundwater quality zone for nitrate contamination; range, township and section; aquifers; and other geospatial data as necessary. Although the geospatial data available for download could be as large as the overall map coverage, currently download files are limited in the Idaho OnePlan™ to data covering a maximum 3 mile×3 mile area to make the download manageable across regular phone lines. This area is ample for farm or ranch planning activities and, hence, no substantive sacrifice need be made to accommodate this download size limitation.

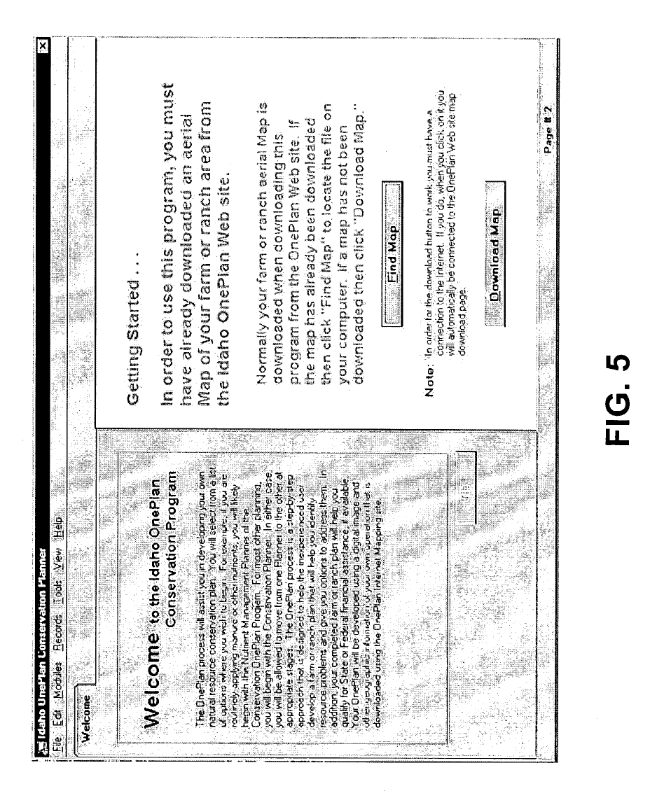

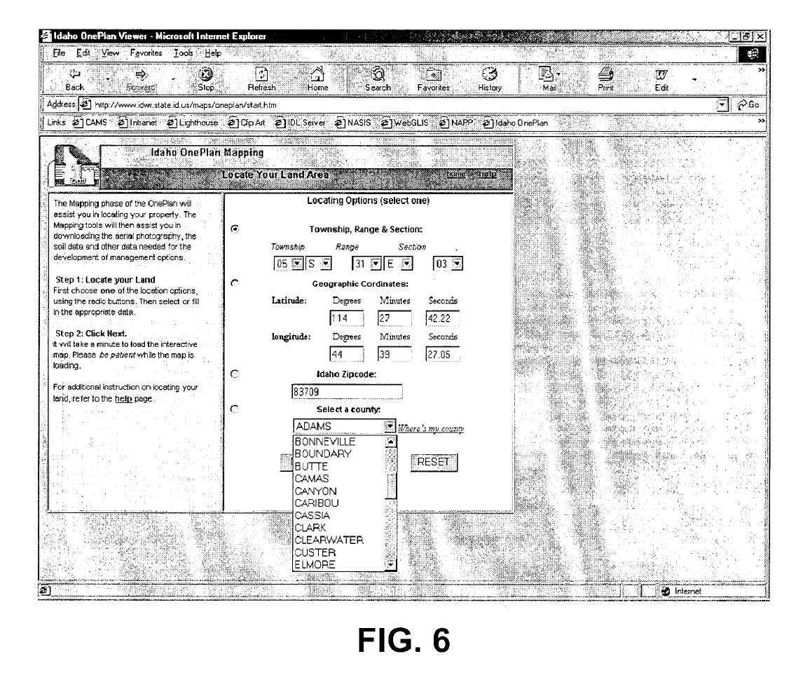

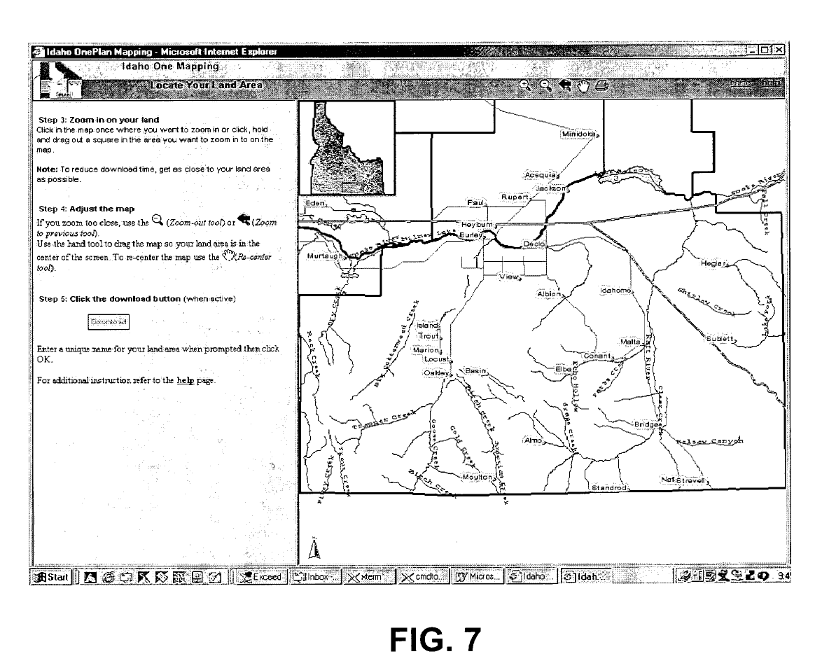

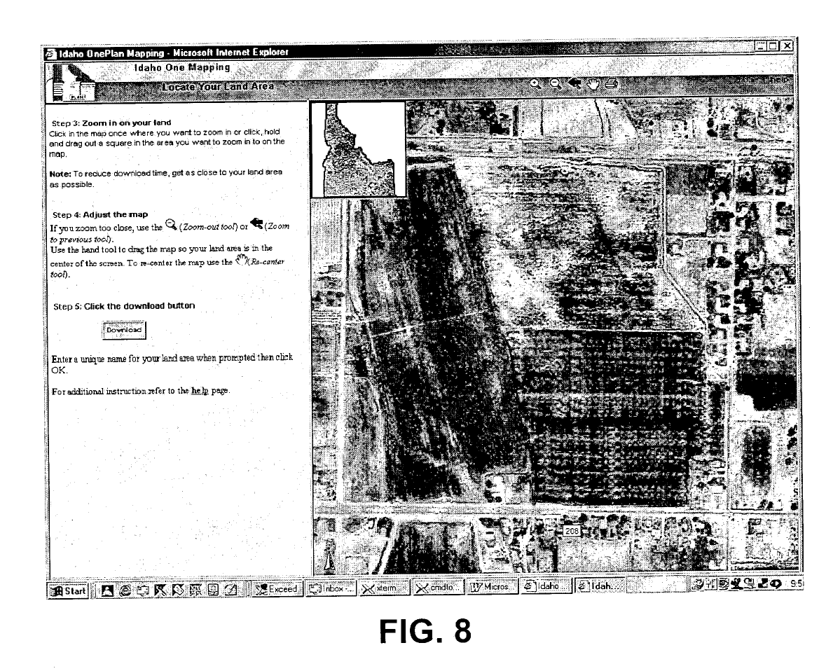

The producer or other user initiates the planning process by launching the Idaho OnePlan™ program on his personal computer. The program may be downloaded from the web service or otherwise installed on the producer's PC. Initially, the user is prompted to find an existing map or, if the site has not yet been mapped, then to download a map as indicated on the opening screen shown in FIG. 5. When the download map option is selected, the program automatically launches the user's browser to establish an on-line connection to the web service hosting the mapping program of module 20 in FIG. 4A. Mapping allows the Idaho OnePlan™ program to identify site specific geospatial information for the target farm or ranch necessary to determine appropriate resource management activities (step 180 in FIG. 4A). Once the program is initiated, the user is presented with four options for locating the general area of the farm, ranch or other agricultural site, as shown in the screen of FIG. 6. The user locates the area by designating the township, range and section to locate the site, the geographical coordinates by latitude and longitude, the Zip Code, or the county, and the designated area is displayed. If the county is selected, for example, a map of the county is displayed as shown in the screen of FIG. 7. The user is prompted in this screen to click on the map near the site and then zoom in until an aerial photograph is displayed, as shown in FIG. 8. The digital image is displayed only when the viewing area is smaller than 6 miles×6 miles. The user is prompted to center the target site on the area displayed and then initiate the download by selecting the download button, which is currently only activated when the selected area is 3 miles×3 miles or smaller.

When the download button is selected, the program automatically identifies the geospatial information associated with the imaged area (step 180 in FIG. 4A) and compiles that data into a download file or group of files containing the geospatial data (step 182 in FIG. 4A). All of the data in the download files is, preferably, compiled into a format compatible with Geologic Information System (GIS) applications. Geospatial data is associated with the digital imagery of the aerial photographs, and compiled into GIS files, using ArcIMS® mapping software commercially available from ESRI of Redlands, Calif. Image data, for example, is downloaded as a georeferenced JPG format file, geospatial coverage of various thematic layers such as soils, water quality, and watersheds, in ESRI shapefile format, and corresponding data in dBase (.dbf) database format.

In the Idaho OnePlan™, all of the geospatial data available at the web service for the 3 mile×3 mile target area is automatically sent to the user when the download button is selected and the user follows the download process. In an optional feature, the user may be presented with a list of the geospatial data that may be selectively downloaded separately, or not at all. While this option may be desirable for more sophisticated users or where the available data is to voluminous to handle efficiently, automatically downloading all available data simplifies the process and is adequate for most users in most areas.

PC Based Decision Support Program. Referring to FIG. 4A, when the GIS files are downloaded, they are automatically imported into the PC based decision support program 22 running on the user's PC (step 184). Step 186 reflects the incorporation into PC program module 22 of process requirements necessary to produce a plan that addresses applicable regulatory requirements. These process requirements were determined by the design teams in step 112 of the overall program development methodology illustrated in FIG. 1.

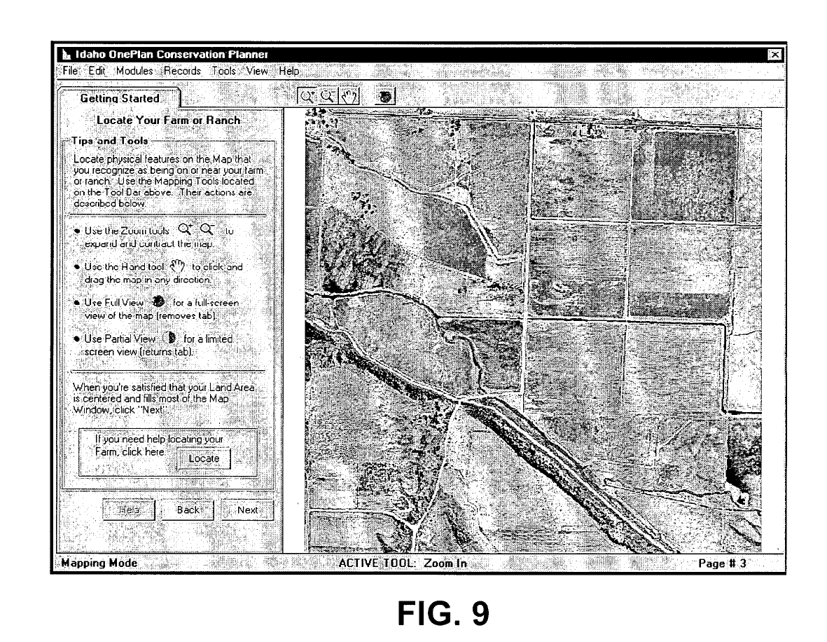

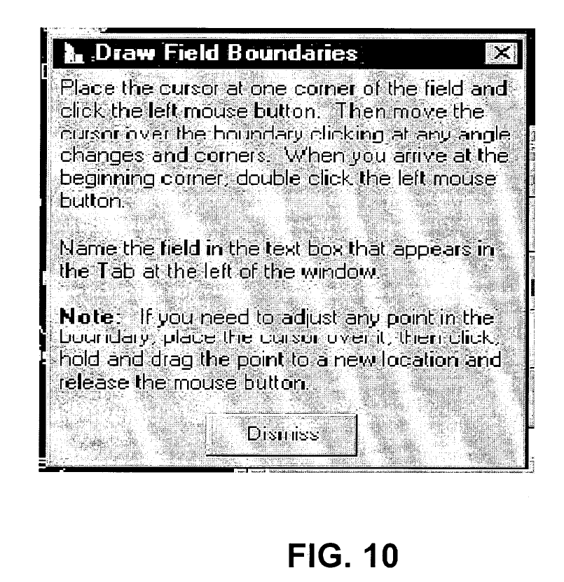

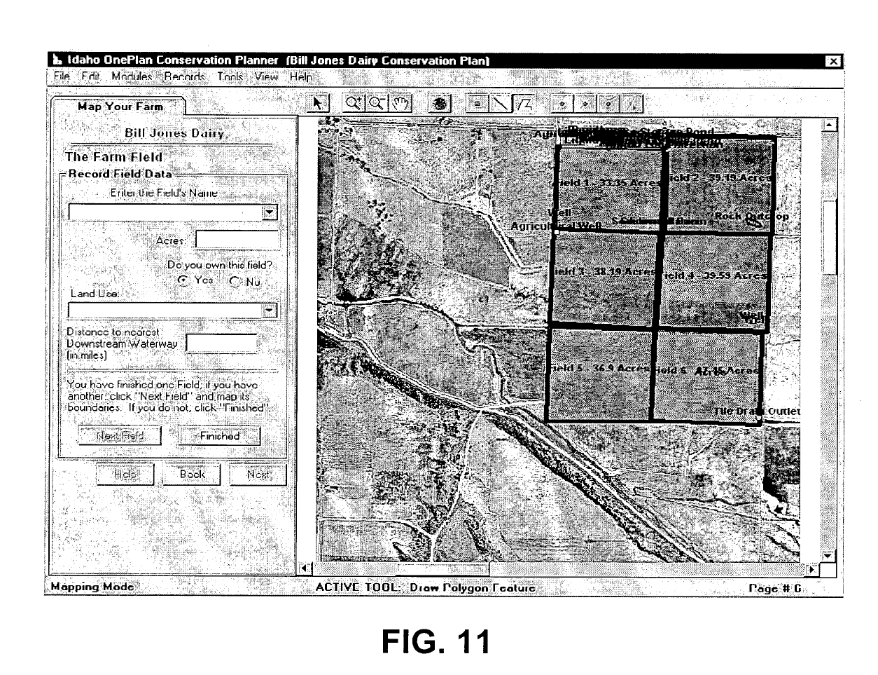

The digital image reflected in one of the GIS files downloaded from the web service is displayed to the user, as shown in the screen of FIG. 9. Next, and referring again to FIG. 4A, the farm or ranch fields or other planning units are now defined (step 188) along with site or facility specific characteristics for each planning unit (step 190). In the example illustrated in the figures, the user is prompted to outline and identify his farm fields as shown in the screens of FIGS. 10 and 11. The user is also asked to specify ownership and the current use of the land. The land area of each field is automatically calculated and reported in acres. In the screen of FIG. 11, for example, Field 1 is 33.25 acres, field 2 is 39.19 acres and so on for each field outlined and identified by the user.

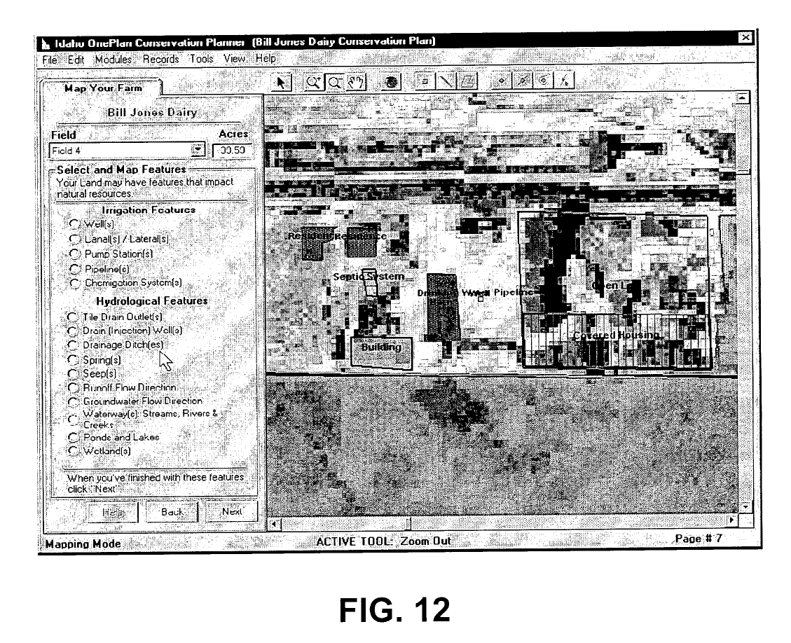

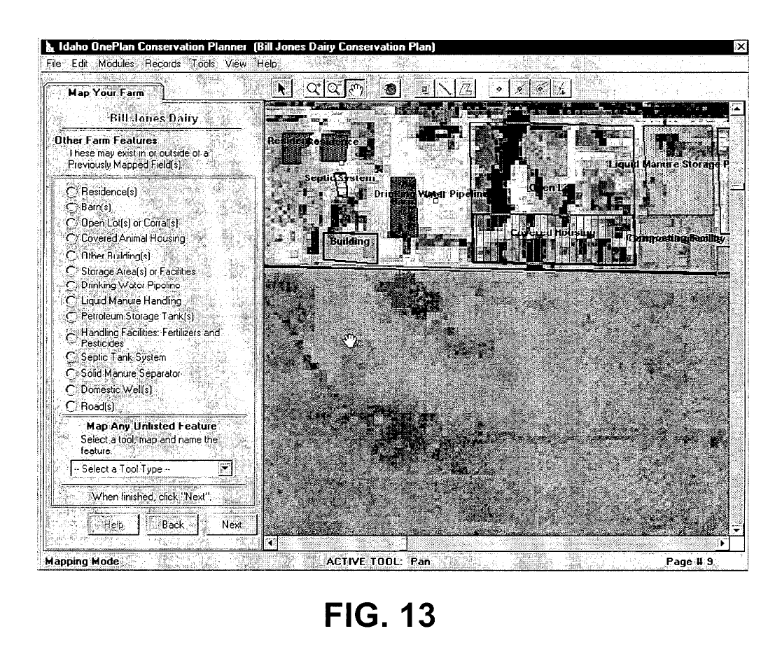

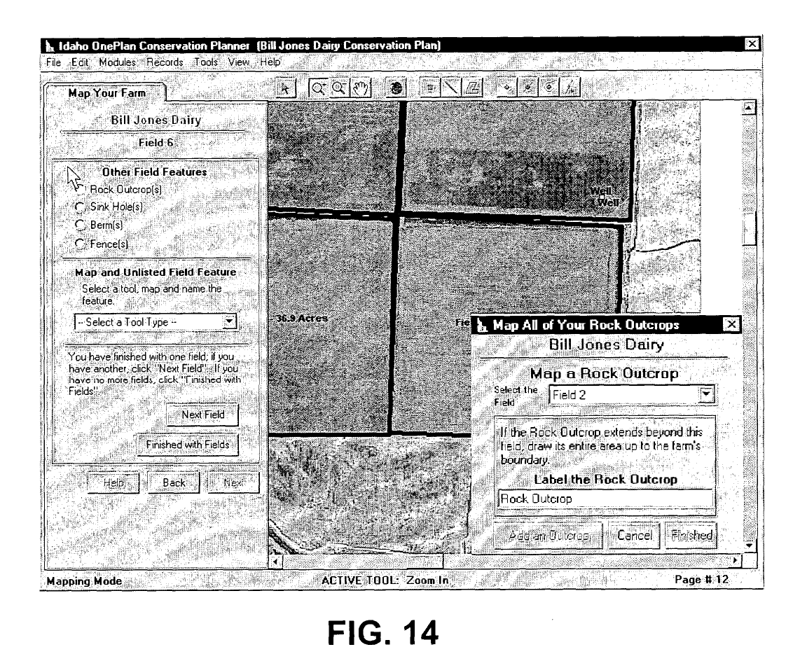

Once the fields have been outlined and identified (step 188), numerous site specific soil calculations are made using the soil geospatial coverage that will be used to characterize the planning area. The user is prompted to identify characteristics of the fields that might not be part of the geospatial data downloaded from the web service (step 190). For example, the user may identify irrigation and hydrological features as shown in the screen of FIG. 12. Irrigation features include wells, canals, pump stations, pipelines and chemigation systems. Hydrological features include drain outlets, drain wells, drainage ditches, springs, seeps, runoff flow direction, groundwater flow direction, and streams, river, ponds, lakes and other wetlands. The user is also prompted to identify farm features, as shown in the screens of FIGS. 13 and 14, including: buildings, open lots and corrals, storage areas and facilities, drinking water pipelines, liquid manure handling facilities, petroleum storage facilities, chemical handling facilities, septic systems, solid manure separators, domestic wells and roads (FIG. 13); rock outcrops, sink holes, berms and fences (FIG. 14); along with any significant site features not listed.

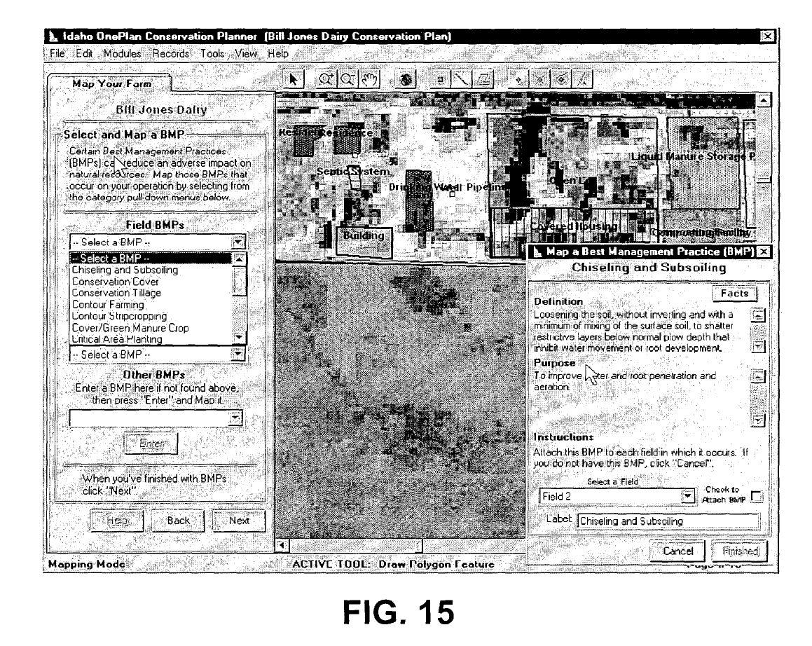

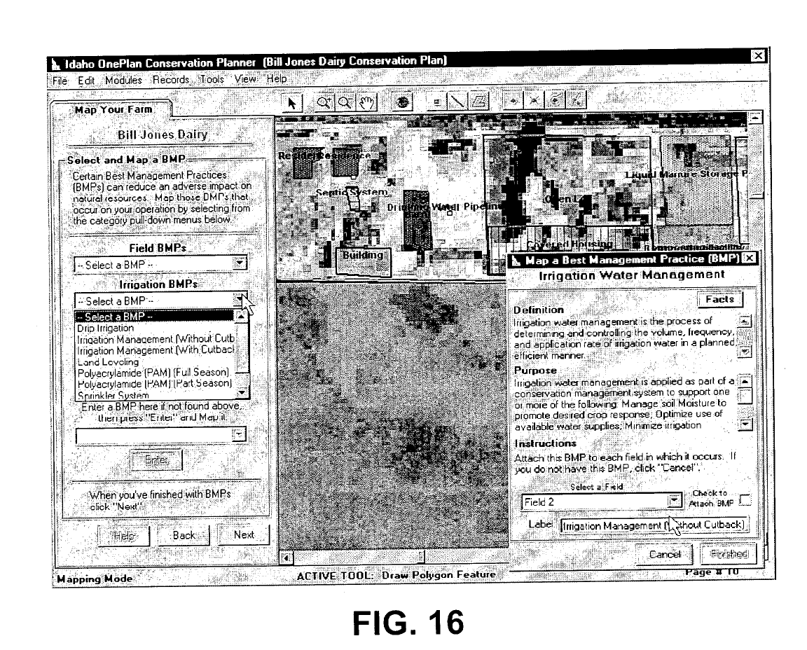

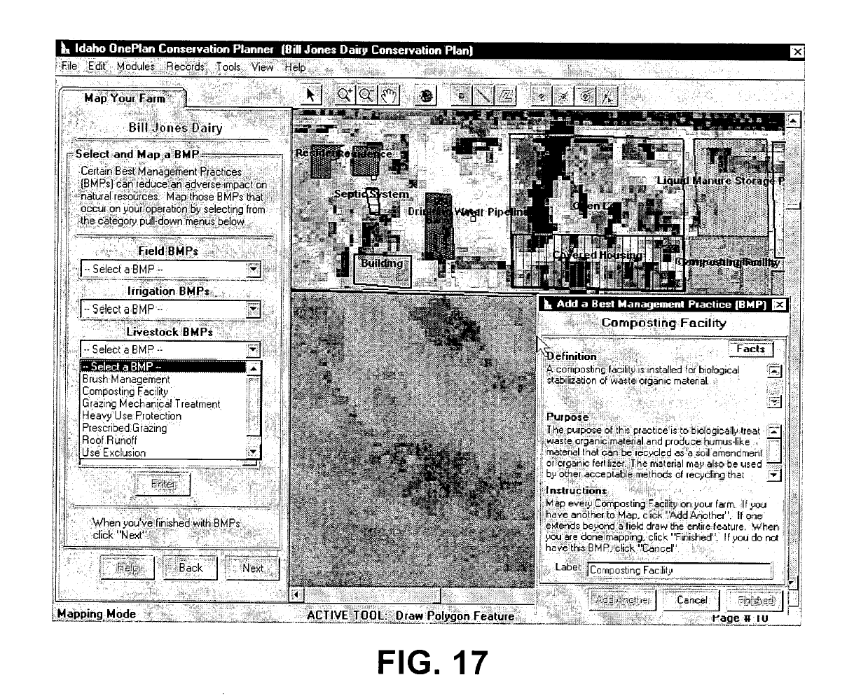

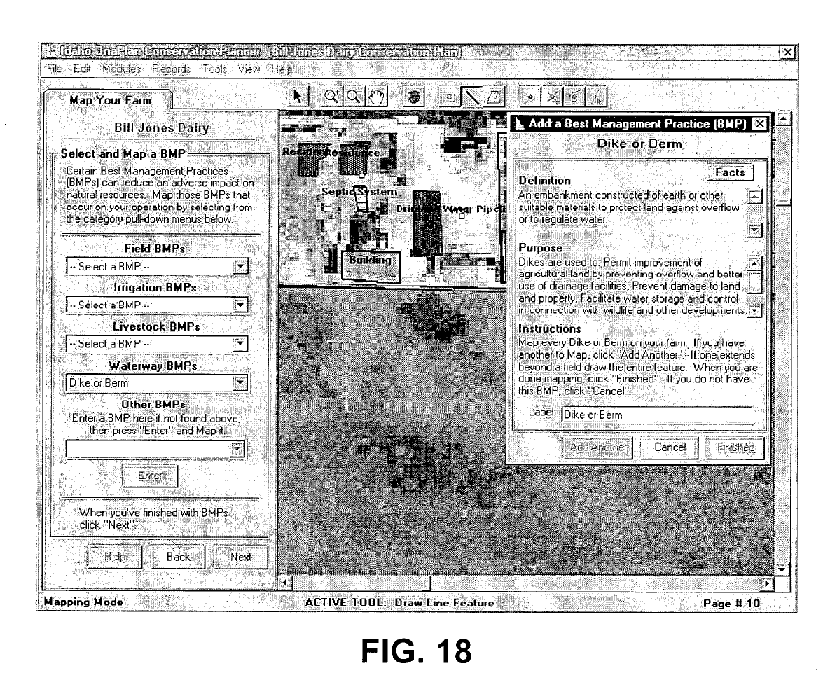

Next, the user is prompted to identify Best Management Practices (BMPs) that are already being implemented in each field or other planning unit, as illustrated in the screens of FIGS. 15-18. The user may identify these BMPs from a drop down menu of Field BMPs (FIG. 15), Irrigation BMPs (FIG. 16), Livestock BMPs (FIG. 17), Waterway BMPs (FIG. 18), and the user may identify any BMPs not listed in the drop down menus (FIGS. 15,16 and 18).

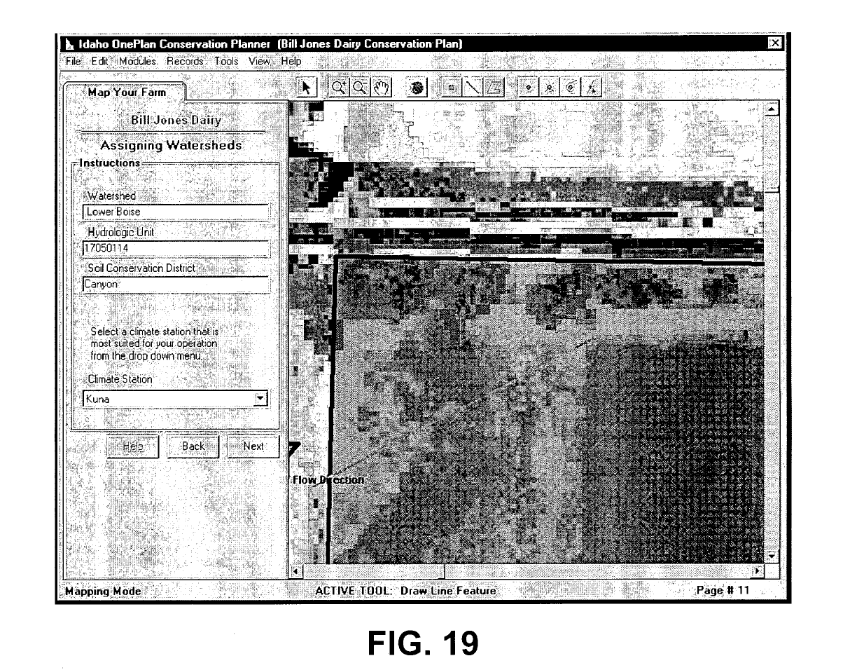

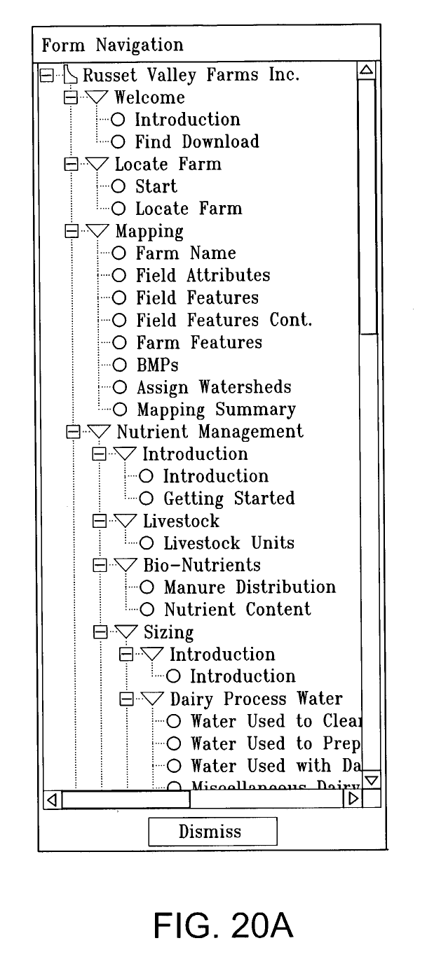

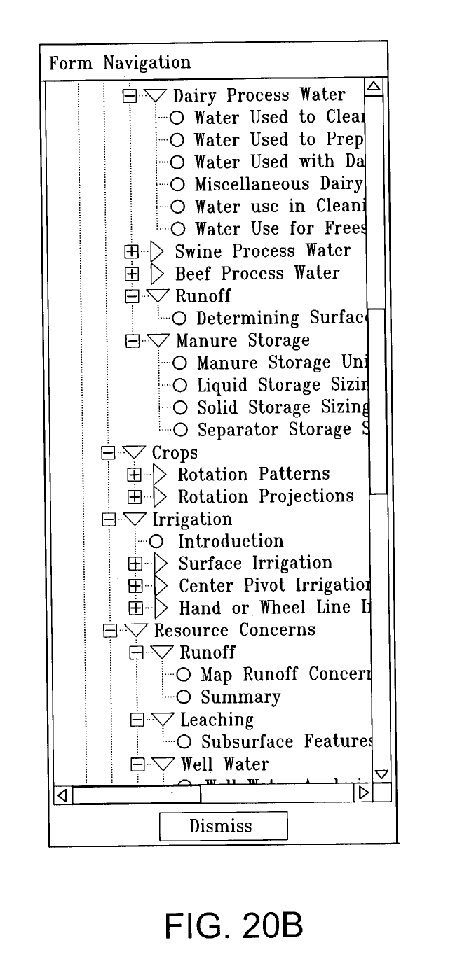

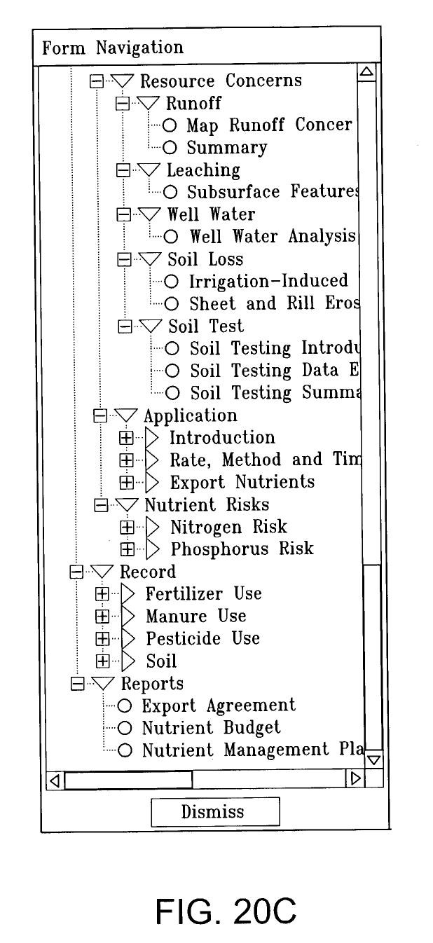

As a last step in the process of defining facility and site characteristics, the program populates watershed, hydrologic unit and Soil and Water Conservation District cells with data from GIS files downloaded from the web service, and prompts the user to identify the site climate station or a station that most closely resembles the climatic conditions at the site, all as shown in the screen of FIG. 19.

Referring again to FIG. 4A, the user is now ready to select the desired planning module (step 192). Planning modules may include, for example, conservation, nutrient management, grazing management and habitat management modules 24-30 or any other modules 32 deemed necessary or desirable for a particular area. Conservation and nutrient management planning modules are described in U.S. patent application Ser. No. ______ (Attorney Docket No. 01-031-03/4155) filed Jun. 6, 2003 and titled Resource Management Planning.

Web Server With Mapping And Decision Support Program. In another version, illustrated in FIG. 4B, both the mapping module 20 and the decision support module reside on a web server 23. In this version, the producer or other user initiates the planning process by browsing to web server 23 to launch the planning program—the user does not need any specialty programming loaded on his computer. The programming residing on web server 23 transfers the necessary information to the user's PC 25 and displays that information as a graphical user interface 27.

As with the first version described above with regard to FIG. 4A, once the program is initiated, the user is presented with options for locating the general area of the farm, ranch or other agricultural site, as shown in the screen of FIG. 6. The user locates the area by designating the township, range and section to locate the site, the geographical coordinates by latitude and longitude, the Zip Code, or the county, and the designated area is displayed. If the county is selected, for example, a map of the county is displayed as shown in the screen of FIG. 7. The user is prompted in this screen to click on the map near the site and then zoom in until an aerial photograph is displayed, as shown in FIG. 8. The programming automatically identifies the geospatial information associated with the imaged area (step 180 in FIG. 4B), and compiles that data into a file or group of files, preferably the GIS files described above, containing the geospatial data (step 182). The GIS files are imported into the decision support programming (step 184). Step 186 reflects the incorporation into program module 22 of process requirements necessary to produce a plan that addresses applicable regulatory requirements. These process requirements were determined by the design teams in step 112 of the overall program development methodology illustrated in FIG. 1.

The digital image reflected in one of the GIS files imported into the program is displayed to the user, as shown in the screen of FIG. 9. Next, and referring again to FIG. 4B, the farm or ranch fields or other planning units are now defined (step 188) along with site or facility specific characteristics for each planning unit (step 190). In the example illustrated in the figures, the user is prompted to outline and identify his farm fields as shown in the screens of FIGS. 10 and 11. The user is also asked to specify ownership and the current use of the land. The land area of each field is automatically calculated and reported in acres. In the screen of FIG. 11, for example, Field 1 is 33.25 acres, field 2 is 39.19 acres and so on for each field outlined and identified by the user.

Once the fields have been outlined and identified, numerous site specific soil calculations are made using the soil geospatial coverage that will be used to characterize the planning area. The user is prompted to identify characteristics of the fields that might not be part of the geospatial data imported into the program. For example, the user may identify irrigation and hydrological features as shown in the screen of FIG. 12. The user is also prompted to identify farm features, as shown in the screens of FIGS. 13 and 14, including: buildings, open lots and corrals, storage areas and facilities, drinking water pipelines, liquid manure handling facilities, petroleum storage facilities, chemical handling facilities, septic systems, solid manure separators, domestic wells and roads (FIG. 13); rock outcrops, sink holes, berms and fences (FIG. 14); along with any significant site features not listed.

Next, the user is prompted to identify Best Management Practices (BMPs) that are already being implemented in each field or other planning unit, as illustrated in the screens of FIGS. 15-18. The user may identify these BMPs from a drop down menu of Field BMPs (FIG. 15), Irrigation BMPs (FIG. 16), Livestock BMPs (FIG. 17), Waterway BMPs (FIG. 18), and the user may identify any BMPs not listed in the drop down menus (FIGS. 15, 16 and 18).

As a last step in the process of defining facility and site characteristics, the program populates watershed, hydrologic unit and Soil and Water Conservation District cells with data from GIS files downloaded from the web service, and prompts the user to identify the site climate station or a station that most closely resembles the climatic conditions at the site, all as shown in the screen of FIG. 19.

In the version of the decision support program shown in FIG. 4B, the conservation planning module 24 is implemented to determine whether or not other planning modules are necessary or desirable. Hence, conservation planning module 24 is implemented after individual facility and site characteristics are defined in step 190. Conservation plans identify resource problems for farm, ranch, dairy and other agricultural operations, specify conservation practices that when implemented are expected to solve those problems, and establish a schedule for implementing the conservation practices. Once a conservation plan is developed through conservation module 24, nutrient management and/or conservation practices may be selected (step 192) and plans developed through management planning modules 26-32.

A computer “program” or computer “programming” refers to any organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Computer program components described herein may be embodied in any computer-readable medium for use by or in connection with an instruction execution system such as a computer/processor based system or other system that can fetch or obtain the logic from the computer-readable medium and execute the instructions contained therein. A computer-readable medium is any medium that can contain, store, or maintain programming for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only memory (ROM), an erasable programmable read-only memory, or a portable compact disc.

The present invention has been shown and described with reference to the foregoing exemplary embodiments. Other embodiments are possible. For example, the PC based decision support program need not produce a plan that addresses all regulatory requirements. The program can still realize substantial utility without meeting all regulatory requirements. The mapping module need not be accessed over the Internet and the decision support program could reside on a web server, or at some other location remote from the producer. While it is expected that Internet accessible mapping will offer the most convenient access for agricultural producers, mapping data might also be made available through an intranet or on CD ROMs. It is to be understood, therefore, that these and other various forms, details, and embodiments may be made without departing from the spirit and scope of the invention.

What is claimed is:

1. A method for resource management planning, comprising:
compiling all regulatory requirements applicable to a resource;
identifying resource conditions that satisfy the compiled requirements; and
selecting management practices that will satisfy the identified conditions when implemented.

2. The method of claim 1, further comprising identifying all regulatory agencies interested in the compiled regulatory requirements and wherein identifying management practices includes the identified agencies agreeing that the management practices will satisfy the identified conditions when implemented.

3. A method for resource management planning, comprising:
compiling regulatory requirements applicable to a resource;
identifying the resource conditions necessary to satisfy the compiled requirements;
developing a computer implemented tool for selecting management practices that will satisfy the identified conditions when implemented; and
all regulatory agencies interested in the compiled regulatory requirements agreeing that the selected management practices will satisfy the identified conditions when implemented.

4. The method of claim 3, wherein compiling regulatory requirements applicable to a resource comprises compiling all regulatory requirements applicable to the resource.

5. A method for agricultural resource management, comprising:
making all regulatory requirements applicable to an agricultural resource available to an agricultural producer through a single source; and then
selecting management practices that will satisfy the regulatory requirements when implemented.

6. The method of claim 5, further comprising implementing the selected management practices.

7. A computer readable medium having instructions thereon for:
making all regulatory requirements applicable to an agricultural resource available to an agricultural producer through a single source; and then
selecting management practices that will satisfy the regulatory requirements when implemented.

8. The medium of claim 7, wherein the medium resides on a web server accessible over the Internet.

9. The medium of claim 7, wherein the medium comprises plural media residing on a web server accessible over the Internet and on a client remote from the web server.

10. A computer readable medium having instructions thereon for:
listing all regulatory requirements applicable to a resource; and then
selecting management practices that will satisfy the regulatory requirements when implemented.

11. A resource management plan that addresses all regulatory requirements applicable to a resource.

12. A method for resource management, comprising generating a resource management plan that addresses all regulatory requirements applicable to a resource.

13. A computer readable medium having instructions thereon for generating a resource management plan that addresses all regulatory requirements applicable to a resource.

14. A method for resource management planning, comprising:
a resource producer generating a resource management plan;
a person other than the producer certifying that the plan addresses all applicable regulatory requirements; and
implementing the plan.

15. The method of claim 14, wherein a resource producer generating a resource management plan comprises a resource producer interacting with a computer program to generate the resource management plan.

16. The method of claim 14, wherein a person other than the producer certifying that the plan addresses all applicable regulatory requirements comprises a person other than the producer certifying that the plan addresses all regulatory requirements applicable to the resource.

17. The method of claim 14 further comprising monitoring implementation of the plan.

18. The method of claim 16, wherein:
implementing the plan comprises the producer implementing the plan; and
monitoring implementation of the plan comprises a person other than the producer monitoring implementation of the plan.

19. A method for resource management planning, comprising:
a resource producer generating a resource management plan that addresses all regulatory requirements applicable to a resource;
the resource producer notifying a regulatory agency that the plan has been produced; and
the resource producer implementing the plan.

20. The method of claim 19, wherein a resource producer generating a resource management plan comprises a resource producer interacting with a computer program to generate the resource management plan

21. The method of claim 19 further comprising the regulatory agency monitoring implementation of the plan.
